(19) United States
(12) Patent Application Publication
(10) Pub. No.: US 2014/0272057 A1
(43) Pub. Date: Sep. 18, 2014

(54) NEW SHREDDING ROLL FOR THE PRODUCTION OF HIGH STRENGTH SNACKS

(71) Applicant: Intercontinental Great Brands LLC, East Hanover, NJ (US)

(72) Inventors: Jan Karwowski, Franklin Lakes, NJ (US); Vani Vemulapalli, Whippany, NJ (US)

(73) Assignee: Intercontinental Great Brands LLC, East Hanover, NJ (US)

(21) Appl. No.: 14/350,045

(22) PCT Filed: Oct. 5, 2012
(86) PCT No.: PCT/US12/59001

§ 371 Date: Apr. 4, 2014

Related U.S. Application Data
(60) Provisional application No. 61/544,213, filed on Oct. 6, 2011.

(51) Int. Cl. A21D 13/00

(52) U.S. Cl. CPC A21D 13/0058
USPC 426/497

(57) ABSTRACT

The present invention relates to a method and apparatus for producing thin, crisp shredded snacks having a substantially flat, chip-like appearance and texture. The snacks produced by the method of the present invention have characteristics of both shredded and sheeted snacks. The shredded snacks are produced by compression of a shredded laminate to avoid the fonnation of a puffed or pillowed appearance, as well as, the thick cracker-like appearance. Despite the compression, the shredded snacks exhibit a substantially uniform shredded, net-like appearance upon their surfaces and visually discernible individual shred layers. The strength of the laminate is sufficient to continuously undergo cutting, transferring, and packaging operations during mass production without tearing or breaking. The shredded snacks produced by the method are sufficiently strong for the addition of greater concentrations of inclusion materials and fillers during production and for dipping into and scooping of dips or sauces without breaking consumption.

### FIELD OF THE INVENTION

The present invention relates to a method of producing thin, crisp shredded snacks having characteristics of both shredded and sheeted snacks. The snacks are produced by a unique shredding process and compression of a shredded laminate.

### BACKGROUND OF THE INVENTION

Shredded products are popular with consumers not only for their unique texture and taste but also for their wholesomeness and nutrition. They generally contain good to excellent source of whole grains. Whole grains not only offer fiber advantage but also other benefits such as phytochemicals, antioxidants, and micronutrients. In some shredded products the fiber level is further increased by adding fiber from various plant sources.

Broadly speaking, shredded products sold in the market place are categorized as either sweet or savory. Sweet shredded cereals are usually consumed with milk for breakfast. Savory products such as crackers, crisps, and snack mixes are consumed anytime of the day. Shredded cereals could be fortified with essential vitamins and minerals, but shredded snacks are generally not fortified with essential vitamins and minerals.

In the production of shredded ready-to-eat snacks made from whole grains, a plurality of shredded layers are laminated upon one other, and the laminate is cut, dockered, and baked in high temperatures to provide products having a distinctly visible shred pattern on their opposing major surfaces. The shredded weaves provide visual attractiveness and a unique, crispy texture that connotes a healthy and hearty products with natural product appeal. Also, the shreds provide increased surface area and deliver a robust flavor through, for example, texture and mouth-feel. Production of a thin, chip-like baked product from shredded laminated layers would provide an attractive, flavorful, crispy, wholesome hand-to-mouth baked snack product.

In many shredded type food products, the number of shred layers generally contributes substantially to the puffed, pillowed appearance of ready-to-eat cereal biscuits, and the thick, cracker-like appearance of shredded wheat wafers. The number of shred layers may range up to about 21 layers, with the larger number of sheets being reserved for larger sized biscuits as disclosed in U.S. Pat. No. 4,696,825 (filed Jan. 25, 1985) and U.S. Pat. No. 5,595,774 (filed Dec. 14, 1994). As disclosed in the '825 patent spoon-sized ready-to-eat cereal biscuits generally have from about 6 layers to about 12 layers. Shredded wheat wafers generally have from about 8 layers to about 12 layers as taught in the '774 patent.

When many or even a few shredded layers are laminated, the shred pattern of one layer does not exactly line up with the shred pattern of an adjacent layer thereby creating inter-layer voids or slight surface unevenness from layer to layer. Also, slight ripples may be present across the width of a layer. Additionally, as disclosed in U.S. Pat. No. 548,086 (filed Mar. 15, 1894), the filaments or threads discharged by means of a comb or scraper from the grooves of the shredding rolls have a sinuous form and rough or jagged exterior shape which is designed to also provide small interstices throughout the mass that aerate and lighten the final product. The use of excessive tautness during layer deposition to substantially eliminate ripples or the sinuous form and rough exterior may result in tearing of the layer. As a result of the slight misalignment, and surface layer unevenness, the thickness of the laminate is generally substantially greater than the sum of the thicknesses of the individual layers prior to lamination.

Additionally, upon baking and drying of the dough-like laminate, escaping moisture and hot gases tend to separate the layers even more and contribute to a puffed or pillowed appearance or thick, cracker-like appearance, rather than a thin, chip-like appearance.

Thus, merely reducing the number of shred layers does not necessarily result in a chip-like appearance. Also, excessive reduction in the number of shred layers may substantially reduce the strength of the laminate and its ability to continuously undergo cutting, transferring, and packaging operations during mass production. As a result, such a baked product may be too light and fragile for dipping.

What is needed therefore is a method and apparatus for producing thin, crisp shredded snacks having a substantially flat, chip-like appearance and texture. The snacks produced by the method of the present invention have characteristics of both shredded and sheeted snacks, in that, the snack chips herein, look like shredded snacks but can also substantially perform like sheeted snacks for dipping and scooping during consumption. The chip like snacks can be produced by compression of a shredded laminate, which avoids the formation of a puffed or pillowed appearance of shredded ready-to-eat cereal biscuits or the thick cracker-like appearance of shredded wafers. Even though the laminate undergoes substantial compression, the substantially flat chip-like products exhibit a substantially uniform shredded, net-like appearance upon their major surfaces and visually discernible individual shred layers with clearly visible voids present in each layer.

The strength of the laminate is sufficient to continuously undergo cutting, transferring, and packaging operations during mass production without tearing or breaking. The shreds provide visual attractiveness, a unique, crispy texture, and robust flavor. The baked chip-like shredded snacks are sufficiently strong for dipping into and scooping of dips or sauces without breaking.

### BRIEF SUMMARY OF THE INVENTION

Accordingly, the invention relates to a method for forming a shredded chip-like snack of increased strength comprising the following steps:
a. Transporting cooked grains on a conveyor to a shredder having between about 121 cross grooves and about 240 cross grooves per 5 inch diameter of the shredder,
b. Shredding the cooked grains through the shredder to produce a plurality of shredded sheets;
c. Laminating the plurality of shredded sheets between at least two rolls to produce a laminate;
d. Forming a plurality of high strength snack pieces; and
e. Baking the plurality of snack pieces to obtain a high-strength shredded snack chip.

Preferably, four to six shredded sheets are compressed to obtain a laminate. In some embodiments, the method comprises the step of reducing the thickness of the laminate while transporting the laminate on a conveyor belt through the at least two rolls to obtain a laminate having a shredded appearance.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements and in which:

a. FIG. 1 provides a picture of a prior art snack chip;

b. FIG. 2 provides a picture of a rectangular snack chip of the kind created by the process herein;

c. FIG. 3 is a schematic showing the process for forming the snack chips herein;

d. FIG. 4 shows a portion of a novel rotary shredder used in the process herein;

e. FIG. 5 is a partial view of the shred pattern of a prior art shredder having sixty or fewer cross-grooves; and

f. FIG. 6 is a partial view of the shred pattern of a shredder having between one-hundred twenty-one and two-hundred forty cross-grooves.

### DETAILED DISCUSSION OF THE INVENTION

A method for forming a chip-like shredded snack of increased and improved strength comprises the following steps:
a. Transporting cooked grains on a conveyor to a shredder having between about 121 cross grooves and about 240 cross grooves per 5 inch diameter of the shredder;
b. Shredding the cooked grains through the shredder to produce a plurality of shredded sheets;
c. Laminating the plurality of shredded sheets between at least two rolls to produce a laminate;
d. Forming a plurality of high strength snack pieces; and
e. Baking the plurality of snack pieces to obtain a high-strength shredded snack chip.

In some embodiments, the method comprises the step of reducing the thickness of the laminate while transporting the laminate on a conveyor through the at least two rolls to obtain a laminate having a shredded appearance. In another embodiment of the method, the plurality of shredded sheets comprise two to six shredded sheets that are compressed to obtain a laminate. The thickness of the plurality of shredded sheets (laminate) prior to passing it through the at least two compression rolls ranges from about 0.040 inch to about 0.220 inch. In some embodiments, the thickness of a laminate ranges from about 0.025 inch to about 0.15 inch. In some embodiments, the thickness of the laminate ranges from about 0.055 inch to about 0.062 inch.

The term “bite sized” or “bite size” as used herein it is meant herein those types and kinds of small, edible snacks or candies whereby each individual snack or candy may be consumed by a human in one bite.

By the term “bar sized” it is meant herein those types edible snacks or candies whereby each individual snack or candy may not be consumed by a human in one bite but rather requires multiple bites for full consumption.

In practice, the shredded sheets are obtained from grooved rolls that have circumferential grooves having a depth ranging from about 0.010 inch to about 0.023 inch. The laminate is formed into shaped pieces using a rotary cutter or the combination of long slitting and cross-cutting. The process of longitudinal slitting and cross-cutting form rectangular, triangular or square pieces. Once finished, the shredded snack pieces have a cross-hatched appearance.

By the term “shredder” it is meant herein the combination of two rolls, one of which is a grooved roll and the other of which is a smooth roll, whereby both rolls operate together to produce a shredded laminate.

The process of shredding begins with using clean wheat kernels free of any foreign material such as chaff dust, other grains, stones, sticks etc. Once cleaned, the wheat is ready for cooking. There are two ways of cooking wheat or other grains. The first is to cook them in excess water slightly below the boiling point (at about 210 F) under atmospheric pressure. This process is called immersion cooking. The second process is pressure cooking in which cooking is done under pressure using a limited amount of water.

The cooking vessel for immersion cooking has a horizontal perforated basket that rotates within a stationary housing (about 3.5 feet in diameter and 8 feet long) and is sufficient to hold 50 bushels (approximately 3000 lbs) of raw wheat. It is equipped with water inlet and drains. The water is heated by injecting steam inside the cooker and set temperature of water is maintained using temperature sensing probes. In the immersion cooking process whole wheat kernels are used since they maintain their individual kernel free flowing integrity during cooking. In order to achieve the set cooking temperature rapidly preheated water can be used. Similar size kernels are used to attain uniform cooking.

Cooking is achieved when the kernel endosperm turns from starchy white to translucent gray, which usually requires 30-35 minutes. Analytical technical methods such as Differential Scanning Calorimetry (DSC) or microscopy are also used to quantify the extent of starch gelatinization. The moisture content of the cooked wheat after draining water ranges from about 45% to about 50%. Undercooking and overcooking are both undesirable. Undercooked grains can cause white starchy streaks in the final product. On the other hand overcooking grains can cause over gelatinization which can make the cooked material very moist, sticky, and difficult to handle and process.

In the pressure-cooking process either whole or milled/cracked wheat can be used. Wheat is milled in a mill such as a Fitz mill with a desired screen opening to reduce the wheat into smaller particles. Pressure cooking provides the ability to incorporate additional ingredients along with whole or milled wheat. They are blended with water and other optional ingredients such as other whole grains and non whole grains, starches, proteins, fibers, sugar and/or sugar derivatives, salt, colors, flavors (including sweet and/or savory flavorings), processing aids, inclusions and the like. Instead of milled wheat, partially bumped or flaked wheat can also be used. In the pressure cooking process, a right amount of water is added which is fully absorbed by wheat and other ingredients.

A pressure-cooked grain material has relatively lower moisture content than its immersion cooked counterpart. Pressure-cooking is done at a steam pressure of between about P_{g}-5 psi. to about P_{g}-25 psi at a temperature of between about 110 C. (230° F.) to 132.2 C (270° F.) for a time of 10 to 30 minutes. The cooking time is relatively shorter due to cooking at higher temperature resulting from higher steam pressure. The pressure-cooked whole-wheat berries coming out of the cooker are free flowing. But when milled wheat is used, the exposed starch gelatinizes in the presence of water and forms agglomerates of various sizes. The agglomerated lumps are reduced in particle size using a lump breaker and further sized using a screening device.

The cooked wheat or sized material is discharged out of the cooker and conveyed to the cooling units. The cooling units can be horizontal with vibratory or perforated pans through which cool air is circulated. The objective is to stop the cooking process quickly and surface dry the grain or material to ambient conditions. Cooling to ambient temperature is accomplished in 5 to 10 minutes.

After cooling, the cooked wheat or material is held in large curing or tempering bins. Tempering permits uniform moisture distribution within the particles. The tempering time varies and could be up to 24 hours. During the tempering process the cooked material becomes firm because of retrogradation of starch. The firming of the kernels is vital for obtaining shreds of good strength for cutting and handling of the unbaked product. If the holding time is insufficient, the shreds will be gummy and sticky, and cannot be cut properly and processed.

The tempered grain or material is conveyed to a series of shredding mills either mechanically or pneumatically. It should be free flowing without being sticky so it does not bridge the conveyors and hoppers feeding the shredding rolls.

In the inventive process herein, shredding mills are arranged in a linear series along a common underlying conveyor. A shredding mill roll stand comprises at least one smooth roll and at least one grooved roll and a comb at the bottom of the grooved roll. The comb is positioned against the grooved roll. Each tooth of the comb fits into one of the grooves in the roll. As the roll revolves with its grooves filled with the cooked wheat, the comb tooth picks the wheat shred out of the groove. The two rolls rotate in opposite directions at a differential speed. The speed differential is usually in favor of the grooved rolls by about 4% to about 20% since the material being shredded has a tendency to stick better to the faster roll.

Wear and tear of the rolls is bound to happen since the rolls are constantly rotating and touching each other. Any change in groove dimensions would change the piece weight and texture of the finished product. The groove depth can become shallow due to constant usage and wear and tear of the shredding rolls. On periodic basis the groove depth should be checked and corrected if needed. Grooves of different dimensions can be used on the same shredding line to maintain proper weight control of the unbaked and baked finished product.

Roll surface temperature at optimum shredding conditions for cooked wheat grain ranges from about 35 C (95° F.) to about 46.1 C (115° F.). Some embodiments of the method may include the step of cooling the rolls to optimize the roll temperature. Cooling of the shedding rolls may provide flexibility in the process, formula and can be beneficial in dealing with sticky material. In another example, a formula with lower moisture content and tougher cooked mass that generates heat during processing may benefit by chilling the shredding rolls.

The shredded layer coming out of the rolls is deposited on the conveyor. The layer coming out of the next rolls stand is stacked upon the first layer. The process is continued until the desired number of layers, now laminates are deposited on a moving conveyor. The number of shredded layers is variable and depends on finished product characteristics. In some embodiments, the number of layers comprised in the laminates may range from about 2 to about 21 layers or from about 3 to about 18 layers or from about 5 to 10 layers or from about 4 to 6 layers.

The weave pattern of the plurality of shredded layers can be coarse or fine. Fine or tight weaved layers are sometimes embedded between the coarse weaved shredded layers. One of the advantages of the tight weaves is that they have the ability to capture ingredients or inclusion materials which are in the form of powders or small particles without sifting or falling out of the perforated laminates. Such ingredients or inclusion materials include by are not limited to vitamins, minerals, sugar, salt, spices, seasonings, herbs, seeds, fiber, protein, sweet flavorings, savory flavorings, sweet fillers, savory fillers and the like.

The weave pattern of each snack chip 20 herein is smaller and tighter than that of previous shredded snacks and cereals. In fact, the weave pattern created by the method herein is the smallest pattern achievable while maintaining each snack chip's structural integrity and identity as a shredded snack chip. To be clear, a tighter weave beyond that presented herein would result in a sheeted chip without visible spaces by which a shredded snack chip is defined. Such a sheeted chip's creation is avoided by the process herein.

The weave pattern created herein results from use of a shredder roll having between about 121 and about 240 cross grooves positioned along the length of the shredder roll. The shredder roll used in the method can be coupled to a smooth roll, such type of smooth and grooved shredder roll coupling being well known by persons of skill in the art.

In one particular embodiment, use of a shredder roll having between about 121 and about 240 cross grooves positioned about its length has heretofore not been contemplated. The resultant snack chip that has characteristics of both shredded snacks and sheeted snacks made by such a shredder roll has likewise not been contemplated.

Shredded layers may be dockered using a dockering wheel. The dockering wheel is used to pin the layers together thus preventing the layers from separating or puffing in the oven. Product with too much puffing can result in a finished product with an unacceptable level of breakage. U.S. Pat. No. 6,004,612 (filed Dec. 19, 1997) produced thin crisp or chip-like shredded product by substantially compressing shredded laminates using a smooth compression roll. In formulations with high level of sugars minimum or no compression may be needed since sugars help to naturally fuse the shredded layers together.

When the layers are too densely compressed or compacted it may cause difficulty in driving off moisture during baking. Dockered and/or compressed layers are then transported through an edge trimmer for removal of rough edges of shreds along both sides of the layers. The edge trimmer comprises a bottom support roller for supporting the laminate, as it is edge cut by the top trimming or cutting roll. The trim material is recycled back into the conveyor feeding the shredded rolls and is reused.

The snack chip of FIG. 1 shows a traditional snack chip 10 having multiple cross-hatchings 15 laid over one-another to create multiple layers. Though the layers themselves are not shown, one of skill in the art will recognize that multiple layers of cross-hatchings 15 exist. Such layering of crosshatchings 15 provides desirable texture and mouth-feel of such a snack 10 for consumers of the chips. Persons of skill in the art will also understand that multi-layered chip 10 of a crosshatched construction has certain strength benefits for the prevention of crumbling and the ability of dipping that a snack chip of dissimilar construction will not have.

Though the snack chip 10 of FIG. 1 provides some benefits over snack chips having similar ingredients but dissimilar construction, snack chip 20 of FIG. 2 provides some key improvements over snack chip 10 of FIG. 1. It should be noted herein that snack chip 20 is a fully shredded ready-to-eat snack created from laminates derived from shredding rolls having between about 121 cross grooves and about 240 cross grooves. Snack chip 20, therefore, comprises only those characteristics specific and well known with respect to shredded food products like cereal and snacks, including snack chips.

Snack chip 20 of FIG. 2 is a snack chip of improved and increased strength over snack chip 10 made from an improved process, such process shown in FIG. 4. Specifically, snack chip 20 comprises the qualities of both shredded and non-shredded snack chips. Laminates derived from shredding mills herein are formed from closely compacted strands. Such closely compacted stranded layers in turn form higher compacted weaves throughout the laminates forming each snack product. Snack chip 20 has a similar crosshatched, multi-layer construction to that of snack chip 10. However, snack chip 20 has more cross-hatching and may contain more layers as well. Such cross-hatching and additional layering produces a stronger chip than dissimilarly constructed snack chips and snack chips of similar construction like the snack chip 10 of FIG. 1.

The importance of these improvements are several. With the improved construction of snack chip 20, greater strength in snack chip 20 is gained. The increased strength of snack chip 20 from the increased number of cross-hatches 25 and layers has many benefits for transport and consumption. Such strength increase inhibits breakage of snack chip 20 after its immediate formation, when packaged, when transported in a package, when handled by a consumer and when used for common purposes like dipping in sauces and/or loading sauces onto snack chip 20.

The increased strength gains of snack chip 20 with its cross-hatchings 25 also enhances each chip's 20 ability to accept and sustain the presence of inclusion materials. including but not limited to, flavored powders, herb blends, seeds, fillers, oils and the like. In fact, because of the stronger snack chips 20, greater amounts of inclusion materials may be added to each snack chip 20 without premature fracture of the snack chip 20.

Other important gains for improved snack chip 20 are taste and mouth-feel due to texture. With respect to taste, an improved snack chip 20 having improved strength allows for the presence of 1) inclusion materials like sweet and savory fillers and 2) the presence of such inclusions materials at higher concentrations and weights. The ability to add inclusion materials at increased concentrations increases both the ability to vary the flavor and enhance the flavor of the snack chip 20 disclosed which improves the taste of the snack chip 20 over conventional snack chips.

For example, in an instance where sweet and savory fillers could not be used or could not be used in sufficient quantity during snack chip production, the improved strength of snack chip 20 enables such inclusion use thus changing the taste profile of snack chip 20. In addition, where a dissimilarly constructed snack chip 10 would be limited in its ability to produce taste varieties and/or complex taste bouquets, snack chip 20 is not so limited.

With respect to mouth-feel, the texture of snack chip 20 can be designed to specifically impact a consumer's palette. The term “mouth-feel,” as used herein refers to the quality of texture of edible substances sensed by the human mouth, e.g., the human palette. Such mouth-feel is important in the design of snack chip 20 because such can communicate desirable or undesirable qualities to a consumer. Snack chip 20, because of its cross-hatching 25, can be designed to communicate desirable textures to consumers.

Importantly, the tight weave pattern of snack chip 20 provides some temperature insulative benefits during cooking (e.g., heating) of snack chip 20. The temperature of partially entrapped air within snack chip 20 is ambient. Because of the structure of snack chip 20, air entrapped therein moves slowly within snack chip 20 and escapes out of snack chip 20. During baking, strands of the laminates of snack chip 20 enlarge slightly in response to outside heating. Upon heating, void spaces of snack chip 20 become smaller than what they were prior to baking but such void spaces do not totally disappear in the baking process. Partially entrapped air within snack chip 20 becomes even more entrapped though now more kinetic. Partially entrapped air therefore can maintain a temperature that is below the outside oven temperature. Since oven temperatures for baking snack chips 20 range from about 148.89 C (300° F.) to about 315.5 C (600° F.), much lower internal snack temperatures are very beneficial.

Much lower internal snack temperatures enable a greater structural integrity of snack chip 20 herein. Such greater structural integrity lends itself to taste, mouth feel, strength and overall snack performance. Also, much lower internal snack temperatures enable the use of previously unusable temperature-sensitive inclusions into snack chip 20 herein.

There are many possible edible inclusion materials for snack chip 20 that heretofore could not be used in a snack chip 20 of the variety herein at least because of the temperature requirements of baking. These include but are not limited to all manner of known savory fillers and sweet fillers. One such savory inclusion example is a cheese or dairy based type of inclusion. In some prior art shredded snack chips, some inclusion materials types are unusable. The internal temperature of such prior art shredded snack chips is typically too high, during typical baking, to resist the thermal degradation of these inclusion materials. If the internal temperature of shredded snack chip 10 goes beyond the high temperature of an inclusion used herein, the inclusion may degrade leading to oozing, charring, and/or burning of the inclusion out of the internal cavity of shredded snack chip 10.

Conversely, since the internal temperature of shredded snack chip 20 is far less than that of shredded snack chip 10, sweet or savory inclusions used herein are far less likely to substantially thermally degrade during the baking process and may be included within laminate layers 16 prior to shredded snack chip 20 formation. Similarly, fruit-based inclusions (fillers) and/or savory inclusions (fillers), which are particularly susceptible to thermal degradation, are now usable as an inclusion in shredded snack chip 20 though not usable in shredded snack chip 10. With such a high temperature profile, the use of non-sweet inclusion materials for shredded snack chip 10 is therefore not feasible. The internal temperature of shredded snack chip 10 is too high for such an inclusion to be reliably used in mass production of such shredded snack chips 10.

An apparatus that can be used for producing the thin, shredded chip-like snacks of the present invention is shown schematically in FIG. 3. Cooked, tempered individual, free flowing cereal grains or berries may be supplied to five, serially arranged shredding rolls 40 from feed hoppers 45 for producing five shredded net-like sheets or layers 13. The net-like sheets 13 are deposited one upon the other in substantial alignment.

Shredding rolls 40 are integral to the improved process of FIG. 3. The shredding rolls comprise cross grooves. The cross grooves can comprise a coarse mesh, fine mesh or a combination thereof. The shredding rolls 40, herein, can comprise one preferred type having two hundred forty (240) cross grooves about the length of the roll. In all instances herein, shredding rolls 40 have cross grooves of at least about one hundred twenty-one (121) cross grooves and higher.

With such cross grooving of shredding rolls 40, production of snack chip 20 having improved strength and flavor inclusions and fillers are achieved. As noted hereinabove, the cross grooving enables laminates to be produced having tighter weaves than traditional laminated types of snack chips like that shown in FIG. 1. The term “tighter weaves” as used herein, refers to the characteristic texture of shredded snack chips wherein the produced laminates from shredders of the present method are more tightly woven whereby strands of the laminate are either thinner and/or are such that the individual strands are positioned more closely together.

In the process of FIG. 3, conveyor 8 is aligned below the series of shredding mills 40 for receiving the individual layers as they are transported towards a pair of counter-rotating compression rolls comprising top compression roll 10 and bottom compression roll 12. The five-layer shredded laminate 16 is passed through nip 17 between top roll 10 and bottom roll 12 to obtain a substantially compressed shredded laminate 30 exiting the nip 17.

Going forward compressed laminate 30 is transported through an edge trimmer for removal of rough edges or shreds along both sides of compressed laminate 30. The edge trimmer comprises a bottom support roller for supporting the compressed laminate 30 as it is edge cut by a top trimming or cutting roll. A lower support roll and the trimming or cutting roll rotate in opposite directions as the compressed laminate is trimmed and transported to a second conveyor. The full scope of the process of creating snack chips, except for the novel shredder rolls 40 is recounted in U.S. Pat. No. 6,004,612 which patent is hereby incorporated in its entirety herein.

Another advantage of snack chip 20 from the improved process herein is the ability to create snack chips 20 of highly varied composition and shapes. For example, snack chip 20, herein can comprise, but are not limited to, materials selected from the group consisting of soy, rice, oats, barley, triticale, multigrain materials, corn and mixtures thereof. Suitable snack chips 20 herein can comprise, but are not limited to, shapes selected from the group consisting of squares, triangles, rectangular, pentagons, octagons and the like. In some embodiments, the snack chip 20 can comprise whole or non-whole grains.

FIG. 5 shows a partial view of a shredding roll 60 having sixty cross-grooves or less. Conversely, FIG. 6 shows a partial view of a preferred shredding roll 70 of two-hundred and forty cross-grooves. As shown in FIGS. 4, 5 and 6, teeth 55 cover the surface of each respective shredding roll 50. Teeth 55 are spread evenly about the surface of shredding roll 50, are the same size, and each has the same elevation above the surface of shredding roll 50.

As shown in FIG. 4, shredding roll 50 is preferably cylindrical and covered with teeth 55 from one end of shredding roll 50 to its other end and around the diameter of shredding roll 50. In practice, shredding roll 50 is one of the rolls inserted into the shredding roll pair 40. By its use in shredding roll pair 40, a high strength laminate and thereby snack chips 20 are made.

Whole wheat is a preferred material for the creation of snack chips 20 herein. There are many advantages for using whole wheat. First, wheat berries cook relatively quickly and maintain their integrity during the entire cooking process. Even after cooking, wheat proteins retain their functionality in terms of its elasticity and extensibility and so does starch by retrograding to optimum level to facilitate processing. Secondly, wheat is still shreddable after prolonged tempering of cooked grains or material. It has strength and memory to shred into continuous layers without falling apart. Thirdly, unlike other whole grains, wheat is much more tolerant and forgiving to various unit operations and wide process ranges to produce acceptable finished product.

Each grain is different in its physical and chemical properties. They require different cooking and tempering times and adjustments to processing conditions to obtain optimal properties for shredding and finished product characteristics. A number of different approaches were used to produce shredded products from other whole grains and starchy ingredients.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for forming a shredded snack, comprising:
a. Cooking whole or non-whole grains by immersion or pressure cooking to create cooked grains;
b. Transporting said cooked grains on a conveyor to a shredder having about 121 to about 240 cross grooves per 5 inch diameter of said shredder,
c. Shredding said cooked grains through said shredder to produce a plurality of shredded sheets;
d. Laminating said plurality of shredded sheets between at least two rolls to produce a laminate;
e. Forming a plurality of snack pieces from said laminate; and
f. Baking said plurality of snack pieces to obtain a plurality of high strength shredded snack chips.

2. The method of claim 1 wherein said laminate comprises between about two to about six sheets.

3. The method of claim 1 wherein the thickness of said plurality of shredded sheets prior to passing it through said at least two rolls ranges from about 0.040 inch to about 0.220 inch.

4. The method of claim 1 wherein the thickness of said laminate ranges from about 0.025 inch to about 0.15 inch.

5. The method of claim 1 wherein the thickness of said laminate ranges from about 0.055 inch to about 0.062 inch.

6. The method of claim 1 wherein said shredded sheets are obtained from grooved rollers having circumferential grooves having a depth ranging from about 0.010 inch to about 0.023 inch.

7. The method of claim 1 wherein said laminate is formed into shaped pieces using a rotary cutter or a combination of long slitting and cross-cutting, said shapes including but not limited to squares, rectangles, triangles, pentagonal, octagonal.

8. The method of claim 7 wherein said shaped pieces range in size from bite sized to bar sized.

9. The method of claim 1 wherein said shredded snack comprise a cross-hatched appearance.

10. A method for forming a high strength shredded snack, comprising:
a. Transporting cooked grains to a shredder having 240 cross grooves per 5 inch diameter of said shredder;
b. Shredding said cooked grains through said shredder to produce a plurality of shredded sheets;
c. Laminating said plurality of shredded sheets between at least two rolls to produce a laminate;
d. Reducing the thickness of said laminate while transporting the laminate on a conveyor through said at least two rolls to obtain a laminate having a shredded appearance;
e. Forming a plurality of snack pieces having high strength from said laminate; and
f. Baking said snack pieces to obtain a plurality of high-strength shredded snack chips.

11. The method of claim 10 wherein said at least two rolls reduce the thickness of the laminate by at least about 35%.

12. The method of claim 10 wherein said plurality of shredded sheets comprise two to six sheets.

13. The method of claim 10 wherein the thickness of said plurality of said shredded sheets prior to passing it through said at least rolls ranges from about 0.025 inch to about 0.15 inch.

14. The method of claim 10 wherein the thickness of said laminate ranges from about 0.055 inch to about 0.062 inch.

15. The method of claim 10 wherein said at least two rolls are each driven at the same rotational speed.

16. A method as claimed in claim 15 wherein said at least two rolls comprise a top roll which contacts a top surface of said laminate, and a bottom roll contacting a bottom of said conveyer belt for preventing substantial movement or slippage of said laminate relative to said conveyer belt as said laminate is compressed against the conveyor belt.

17. The method of claim 10 wherein said shredded sheets are obtained from said shredders having grooved rollers, said grooved rollers having circumferential grooves having a depth ranging from about 0.010 inch to about 0.023 inch.

18. The method of claim 10 wherein said laminate is formed into shaped pieces using a rotary cutter.

19. The method of claim 10 wherein said shredded snack has a crosshatched appearance.

20. The method of claim 10 wherein said shredded snack comprises inclusion materials selected from the group consisting of vitamins, minerals, sugar, sugar substitutes, salts, spices, seasonings, cheese-based inclusion materials, fruit-based inclusion materials, herbs, seeds, fiber, protein, oils, sweet paste/fillers, savory paste/fillers and mixtures thereof.

21. The method of claim 10 wherein said shredded snack comprises sweet paste/fillers, savory paste/fillers wherein said sweet paste/fillers, savory paste/fillers create unique, multi-textured snacks.
